(19) United States
(12) Patent Application Publication
(10) Pub. No.: US 2009/0094066 A1
(43) Pub. Date: Apr. 9, 2009

(54) Methods and Systems for Providing Vehicle Insurance

(75) Inventors: Marco Freudman, Chicago, IL (US); Ken Gebhard, Chicago, IL (US)

Correspondence Address: MCANDREWS HELD & MALLOY, LTD, 500 WEST MADISON STREET, SUITE 3400, CHICAGO, IL, 60661, US

(73) Assignee: QUOTEPRO, INC., Chicago, IL (US)

(21) Appl. No.: 11/965,386

(22) Filed: Dec. 27, 2007

Related U.S. Application Data
(60) Provisional application No. 60/977,203, filed on Oct. 3, 2007.

(51) Int. Cl. G06Q 40/00

(52) U.S. Cl. 705/4

(57) ABSTRACT

According to certain embodiments of the present invention, a method is provided for providing insurance including: permitting a customer to access a retail website; retrieving intelligently, from the customer through the website, a first limited set of information pertaining to the customer and a vehicle of the customer; determining, from the first limited set of information, a first insurance rate corresponding to a first insurance policy from a first insurer and a second insurance rate corresponding to a second insurance policy from a second insurer, wherein the first and second rates are determined without intermediately consulting the first and second insurers; evaluating which of the first and second rates is preferable to the customer to determine a preferred insurance policy; displaying information corresponding to the preferred insurance policy to the customer; and providing an option to the customer to purchase the preferred insurance policy. According to an embodiment, the method further includes retrieving intelligently, from the customer through the website, a second limited set of information pertaining to the customer and a vehicle of the customer when the customer opts to purchase the preferred insurance policy. According to an embodiment, the method further includes communicating substantially immediately, to the user, legally binding documents for the preferred insurance policy after the user purchases the preferred insurance policy to form a purchased insurance policy.

This application claims priority to U.S. Provisional Patent Application No. 60/977,203, filed on Oct. 3, 2007, which is herein incorporated by reference.

### BACKGROUND OF THE INVENTION

Generally, the present application relates to an improved method and system for providing insurance to the insurance industry. Particularly, the present application relates to vehicle insurance, although the principles set forth herein may be applicable to other types of insurance—e.g., home owner, renter, property, life, health, and others.

For the discussion herein, insurance transactions can be understood to have two stages: quote and purchase. Historically, obtaining vehicle insurance has been an intricate and relatively slow process for various parties to the transaction. For the customer, there is often the need to converse directly with an agent. The customer may be required to provide an array of personal information and vehicle information before completion of the transaction. Subsequently, there may be a delay of around 7 days to complete the transaction and receive the final insurance documentation.

For the agent and agencies, similar problems are presented. The agencies may need to hire a relatively large number of agents. An agent may manually gather each customer's driving information and manually enter the data. The agent may then have to calculate the appropriate insurance rate for the insurers the agency represented. To accomplish accurate calculation(s), the agent would have to review and follow each insurers' underwriting manual(s). Given the complexity of an agent's job, it may require two to three years to train an underwriter to be able manually calculate vehicle insurance rates.

All of these problems also impact the insurers—e.g., customer delay, agent training delay, provision of up-to-date manuals to agencies, etc. The insurers also are required to execute and authorize certain documents before the policy can be provided to the customer.

Furthermore, small insurers face additional problems. Small insurers may have difficulty in obtaining market exposure, even though their rates may be significantly lower than the giant insurers. The small insurers and agents who represent them have faced additional hurdles in the age of cyberspace. Increasingly, customers are using the internet to obtain vehicle insurance. Large companies like Geico®, Progressive®, and Esurance®, have aggressively marketed their respective websites for internet-based insurance purchases. However, smaller insurers may lack the resources to develop competitive websites, thereby increasing the potential to lose even more market-share.

Thus, there is a need for methods and systems that provide a more efficient process for obtaining vehicle insurance. There is a need for methods and systems that increase exposure and market-share for smaller insurances. Moreover, there is a need for methods and systems that allow smaller insurers to compete in cyberspace more effectively.

### BRIEF SUMMARY OF THE INVENTION

According to certain embodiments of the present invention, a method is provided for providing insurance including: permitting a customer to access a retail website; retrieving intelligently, from the customer through the website, a first limited set of information pertaining to the customer and a vehicle of the customer; determining, from the first limited set of information, a first insurance rate corresponding to a first insurance policy from a first insurer and a second insurance rate corresponding to a second insurance policy from a second insurer, wherein the first and second rates are determined without intermediately consulting the first and second insurers; evaluating which of the first and second rates is preferable to the customer to determine a preferred insurance policy; displaying information corresponding to the preferred insurance policy to the customer; and providing an option to the customer to purchase the preferred insurance policy. According to an embodiment, the method further includes retrieving intelligently, from the customer through the website, a second limited set of information pertaining to the customer and a vehicle of the customer when the customer opts to purchase the preferred insurance policy. According to an embodiment, the method further includes communicating substantially immediately, to the user, legally binding documents for the preferred insurance policy after the user purchases the preferred insurance policy to form a purchased insurance policy. According to an embodiment, the communicating the legally binding documents is performed without intermediately involving the first and second insurers. According to an embodiment, the method further includes automatically uploading information corresponding to the purchased insurance policy to a selected one of the first and second insurers. According to an embodiment, the first limited set of information is intelligently retrieved through assistance of a quote wizard. According to an embodiment, the second limited set of information is intelligently retrieved through assistance of a purchase wizard. According to an embodiment, the method further includes communicating information corresponding to the purchased insurance policy to a selected one of the first and second insurers. According to an embodiment, the information corresponding to the preferred insurance policy includes a rate for liability only, and a rate for full coverage. According to an embodiment, aid website provides persistent sessions to retain information corresponding to interactions of the customer.

According to certain embodiments of the present invention, a virtual agency system is provided for facilitating insurance transactions including: an interface for allowing a customer to interact with the virtual agency; a back-end, wherein the back-end facilitates computation of a plurality of insurance rates from a corresponding plurality of insurers; and a quote wizard for intelligently retrieving a first limited set of information from the customer corresponding to personal and vehicle information of the customer, wherein the quote wizard communicates the first limited set of information to the back-end, wherein the back-end generates a preferred insurance rate from the plurality of insurance rates for display to the customer through the interface. According to an embodiment, the system further includes a purchase wizard for intelligently retrieving a second limited set of information from the customer corresponding to personal and vehicle information of the customer, wherein the purchase wizard communicates the second limited set of information to the back-end, wherein the back-end automatically charges a customer, executes a legally binding insurance policy and communicates the legally binding insurance policy to the customer. According to an embodiment, each of the quote and purchase wizards include at least one rich internet application. According to an embodiment, the customer further interacts with the interface to further adjust a preferred insurance rate by selecting at least one coverage limit. According to an embodiment, the back-end automatically communicates information corresponding to the legally binding insurance policy to a selected one of the plurality of insurers.

According to embodiments of the present invention, a system is provided for providing vehicle insurance including: a customer; a first limited set of information corresponding to the customer, and a vehicle of the customer; a plurality of insurers; a plurality of insurance rates corresponding to the plurality of insurers; and a virtual agency representing the plurality of insurers to the customer, wherein the virtual agency automatically calculates the plurality of insurance rates, and wherein the virtual agency automatically selects a preferred insurance rate from the plurality of insurance rates, and wherein the virtual agency executes and communicates insurance policy documents to the customer without any further human interaction to form a legally binding insurance policy. According to an embodiment, the virtual agency further includes a quote wizard for intelligently retrieving a first limited set of information from the customer for calculating the plurality of insurance rates. According to an embodiment, the virtual agency further includes a purchase wizard for intelligently retrieving a second limited set of information from the customer for purchasing a selected one of the plurality of insurance rates. According to an embodiment, the virtual agency includes at least one website interface, at least one rich internet application, and a back-end. According to an embodiment, the virtual agency automatically communicates information corresponding to the legally binding insurance policy to a selected one of the plurality of insurers.

### DETAILED DESCRIPTION OF THE INVENTION

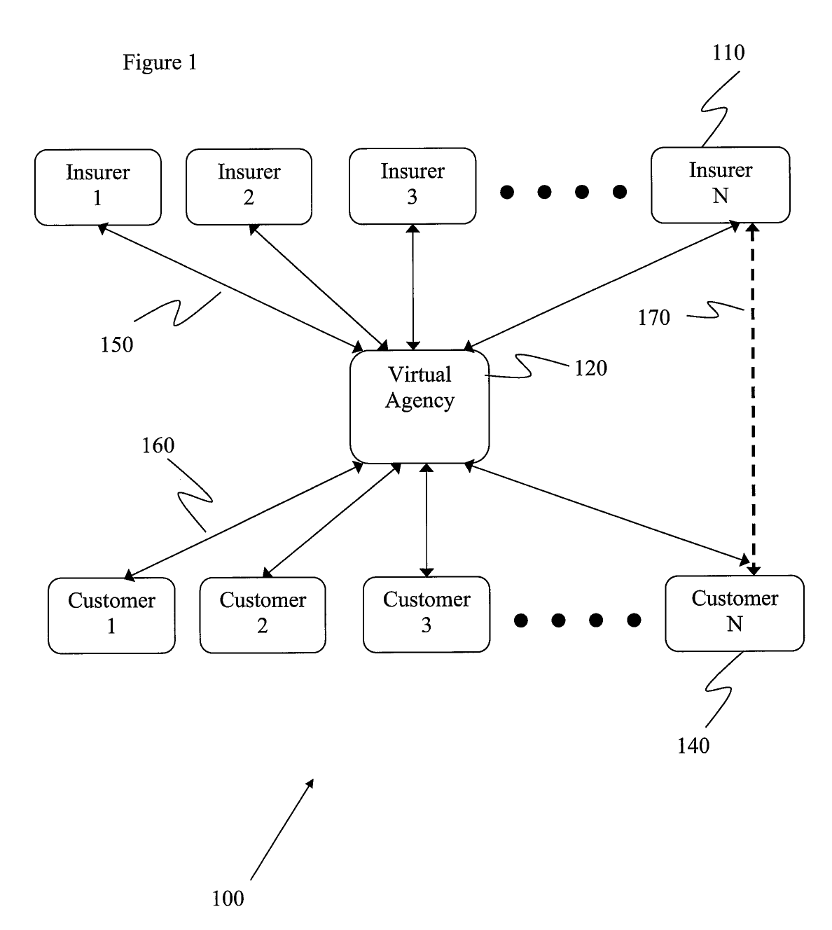

FIG. 1 shows a system for providing insurance transactions, according to an embodiment of the present invention.

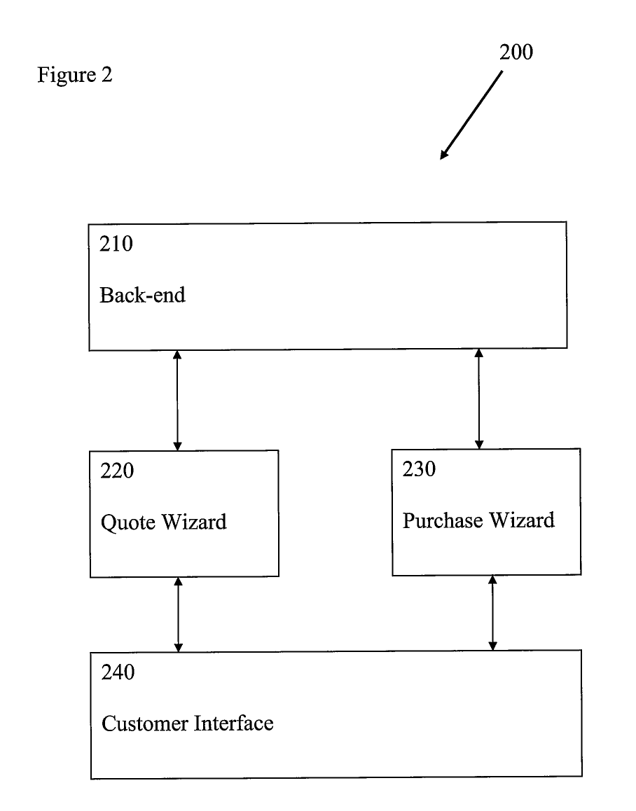

FIG. 2 shows a virtual agency, according to an embodiment of the present invention.

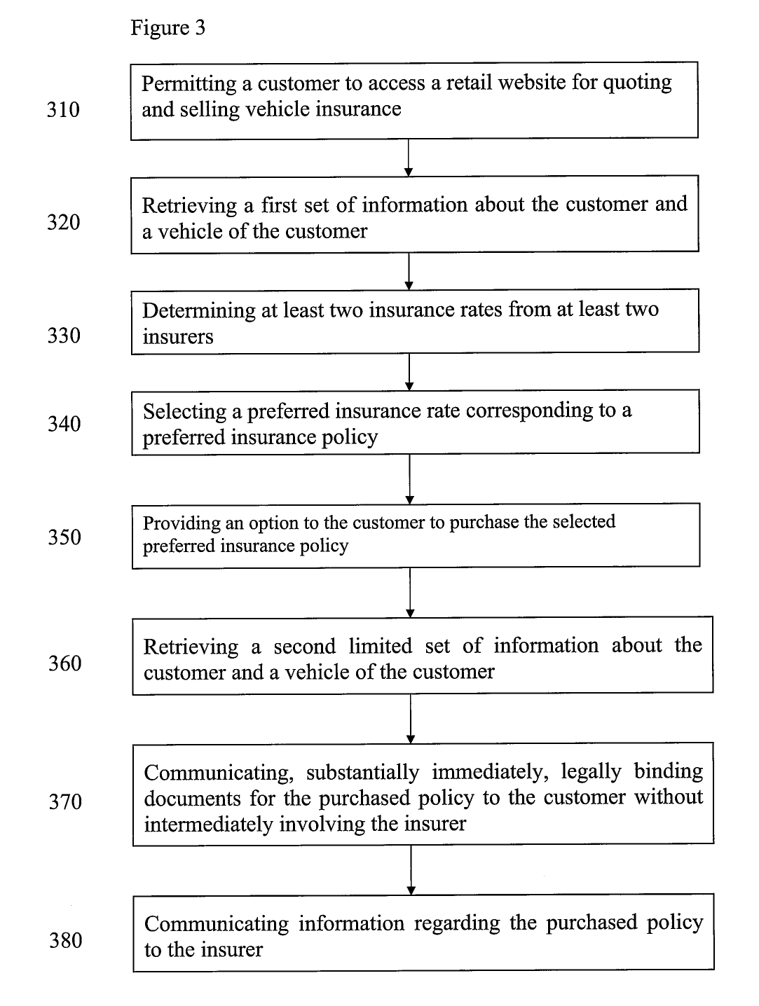

FIG. 3 shows a flowchart for a method of providing insurance transactions, according to an embodiment of the present invention.

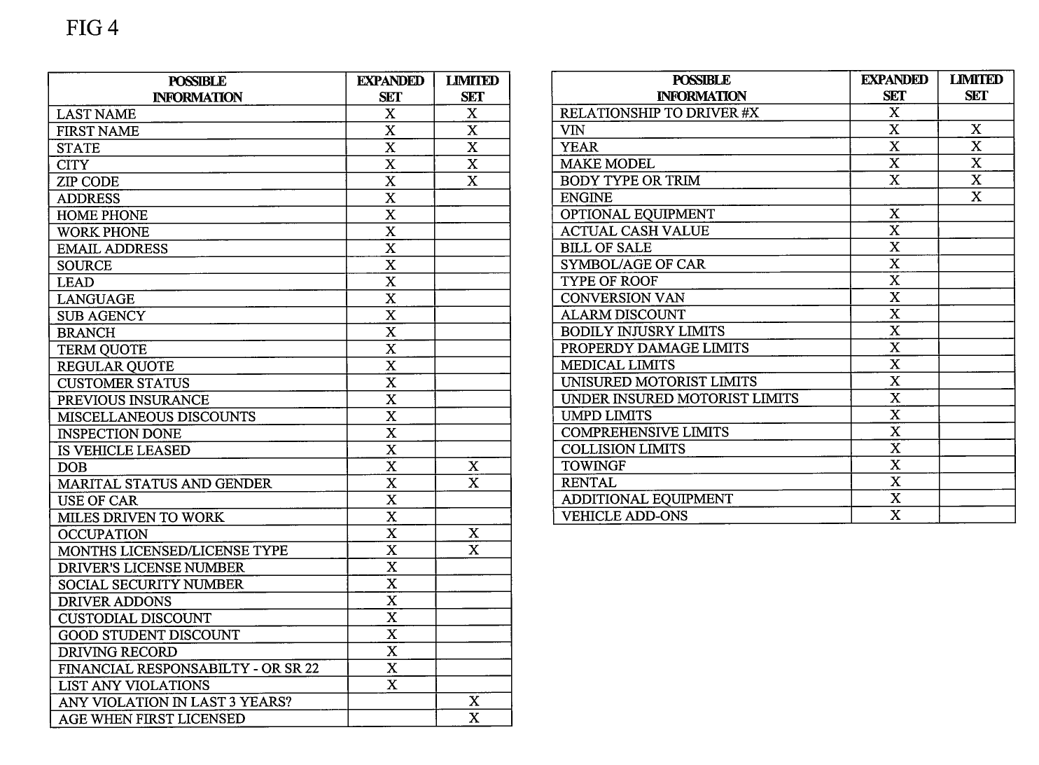

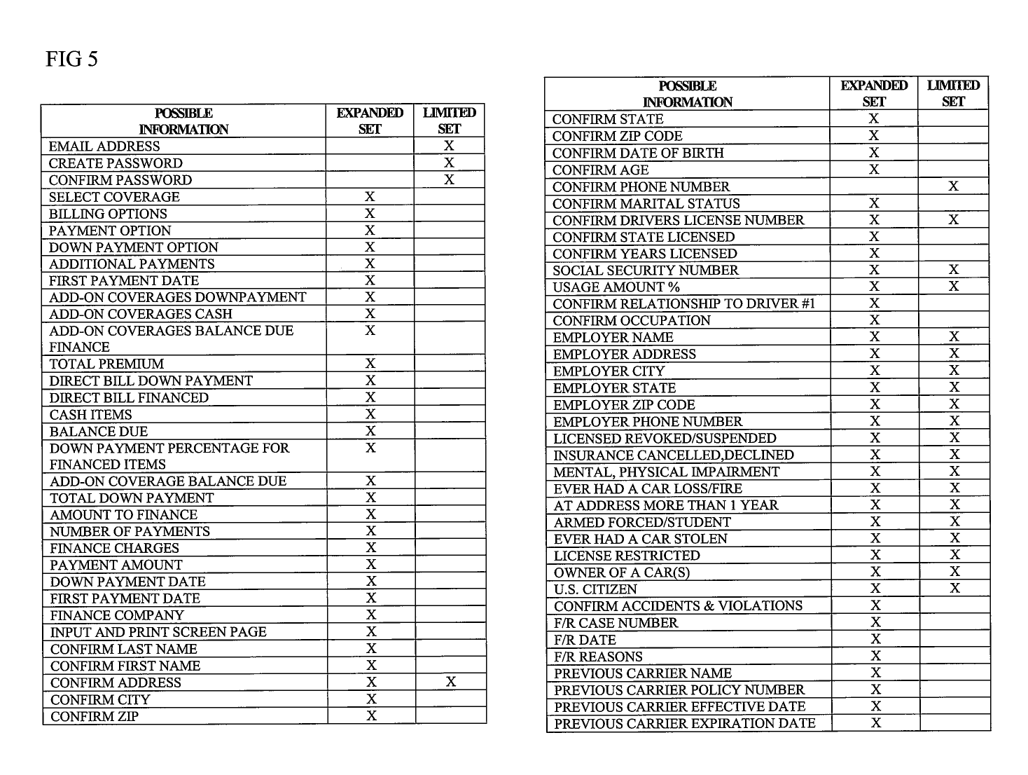

FIG. 4 shows a chart representing a limited set of information for providing a quote, according to an embodiment of the present invention.

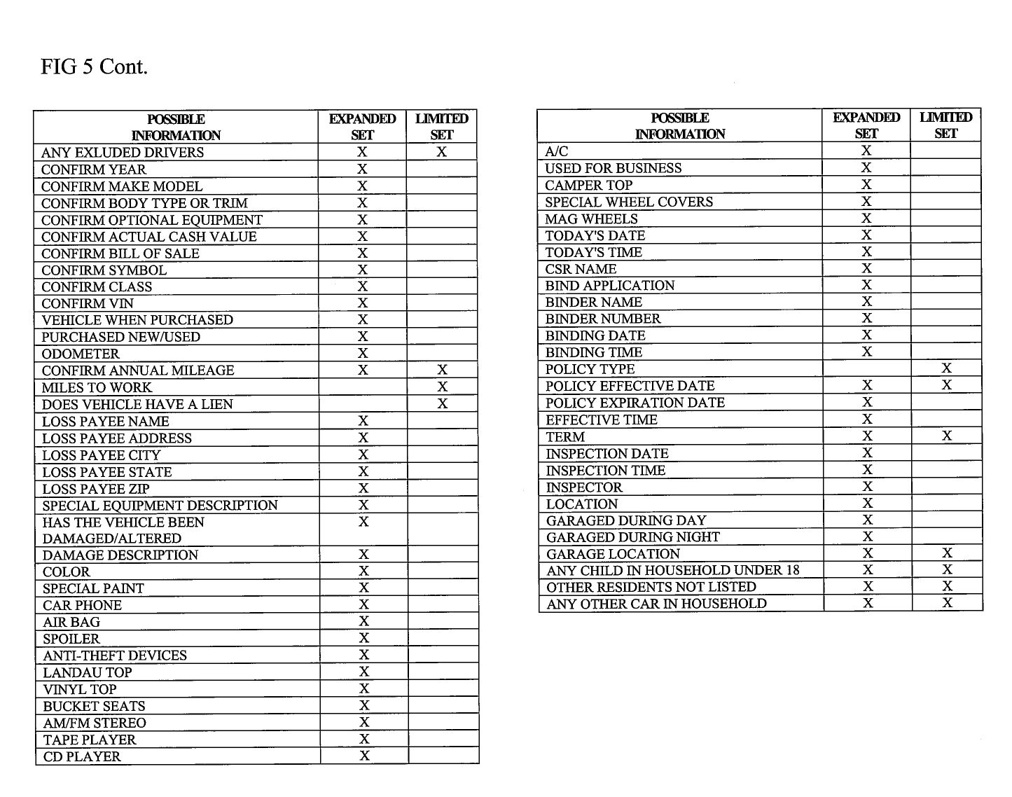

FIG. 5 shows a chart representing a limited set of information for purchasing an insurance policy, according to an embodiment of the present invention.

The methods and systems of the current application are a web-based program to sell insurance that may be powered by the point of sale process. Pursuant to the methods and systems of the current application a customer who has internet access and a credit card may be able to purchase insurance online. The methods and systems of the current application can provide a selected rate to the customer from one of several insurers. Further, a customer may purchase a legally binding insurance policy from one of the several insurers without any further human interaction. Additionally, the customer may receive automatically related documentation (e.g, policy specifics, declaration pages, identification cards, etc.) without any further human interaction. Moreover, the insurer may automatically receive information corresponding to the purchased insurance policy.

FIG. 1 shows a diagram of a system for providing insurance transaction(s), according to an embodiment of the present invention. The system 100 includes, but is not limited to, insurer(s) 110, a virtual agency 120, customer(s) 140 a plurality of communication channels 150 between the insurer(s) 110 and the virtual agency 120, a plurality of communication channels 160 between the virtual agency and the customer(s) 140, and an optional channel 170 between the customer(s) 140 and the insurer(s) 110.

The insurer(s) 110 may be insurance providers that are capable of providing legally binding insurance policies for vehicle insurance. Vehicles may include, but are not limited to, cars, trucks, vans, motorcycles, boats, all-terrain vehicles, snow-mobiles, aircraft, commercial trucks and the like. The customer(s) 140 may be one or more individuals (or agents thereof) who own a vehicle (at least in part), and/or who are capable of purchasing insurance for the vehicle.

The communications channels 160 and 150 may be through the internet, or similar. The communications channels 150 and 160 may be secure and encrypted, for example. The communications channels 150 and 160 may operate over the same communications media channels, and/or may operate over distinct communications media channels (e.g. public internet and private intranet). A customer may be designated an individual server to store statistical data and partially completed deals (e.g., leads). Completed deals or partially completed deals in which an email address has been provided may be stored via an HTTPS post to an Oracle back-end database.

The virtual agency 120 creates relationships (or potential relationships) between a customer 140 and a plurality of insurers 110. The broker 120 can operate substantially automatically. The broker 120 may perform a variety of tasks/functions. The broker 120 may provide an interface for a customer 140. The customer 140 may interact through the interface with respect to a variety of insurance related aspects. For example, the interface may permit the customer 140 to enter personal information and/or information related to a vehicle of the customer. The customer 140 may be able to select and/or adjust choices related to an insurance policy. For example, the customer 140 may be able to select coverage limits, type of policy (e.g. liability only or full coverage), deductible, additional drivers, and/or the like.

The broker 120 may intelligently retrieve a limited set of information from a customer 140 to provide an insurance quote. An example of a limited set of information from a customer 140 for providing a quote is shown in FIG. 4, according to an embodiment of the present invention. As another example, the broker 120 may intelligently retrieve a limited set of information from a customer 140 for purchasing an insurance policy. An example of a limited set of information from a customer 140 for purchasing an insurance policy is shown in FIG. 5, according to an embodiment of the present invention.

The virtual agency 120 may further include a variety of components/sub-systems. For example, FIG. 2 shows a system 200 that is representative of a virtual agency (e.g., broker 120) according to an embodiment of the present invention. The system 200 may include, but is not limited to, one or more back-end 210, a customer interface 240, a quote wizard 220, and a purchase wizard 230.

A customer interface 240 may be a two-way portal between a customer 140, and a virtual agency 120. The interface 240 may dynamically display data to the customer 140. The data may be displayed at a location of the customer, such as through a web browser. The data may include world-wide-web friendly data, such as HTML, SHTML, or similar data. Alternately, intermediate components may translate data from the customer interface 240 for display at a location of the customer (e.g., an intermediate component may convert data from a form provided by the customer interface 240 into a form viewable through a web browser).

The interface 240 may also retrieve data as provided by the customer 120—either directly, or through intermediate components. The customer 120 may provide data to the interface 240 through a variety of ways: drop-down menu selections, check-box selections, radio button selections, text entry, button clicks, etc. The interface 240, either by itself, or in conjunction with other system components, may provide persistent data sessions. A persistent data session may automatically save the customer's information for a period of time—e.g., three hours. The interface 240 may also provide hyperlinks to trigger form posts. The hyperlinks may assist to store information entered by the customer 140 in a persistent session.

A quote wizard 220 may assist to intelligently retrieve a limited set of information from the customer 140. For example, the quote wizard 220 may assist to display prompting questions to the customer 140. The prompting questions—e.g., name, age, address, vehicle information, etc.—may be dynamically determined by the quote wizard 220. For example, the prompting questions may be determined in response to prior information provided by the customer 140.

For example, the quote wizard 220 may prompt the customer 140 to enter a zip code. The quote wizard 220 may then use the zip code to intelligently choose a state, city, and/or county. In the event that the zip code straddles multiple counties or cities, the quote wizard 220 may further prompt the customer 140 to select between various options.

As another example, the quote wizard 220 may prompt the customer 140 to enter a limited set of information to determine the nature of the customer's vehicle. For example, the quote wizard 220 may employ drop down lists, starting with the year and progressing through the make, model, trim and engine until a unique car is selected. The customer may also enter a Vehicle Identification Number (“VIN”) as a shortcut to fill in the other required fields. The quote wizard 220 may dynamically insert or skip prompting questions in order to obtain only the limited set of information necessary to determine a quote.

Likewise, the quote wizard 220 may intelligently prompt the user to enter a limited set of information pertaining to the customer 140. For example, the wizard may prompt the customer to enter the following customer information: name of driver(s), date of birth, gender, license information, occupation, driving violations, and details of the violations.

The quote wizard 220 may facilitate display of one or more insurance quotes to the customer 140. The customer 140 may further interact with the interface 240 to adjust certain aspects of the quote. For example, the customer may be provided two quotes from an insurer. The insurer may be selected by the virtual agency based on a preference—such as a lowest rate. The two quotes may be for full coverage and for liability only. The customer may interact to select coverage limits, deductibles, and other aspects. These interactions may cause the virtual agency to dynamically update the displayed quote(s) to the customer.

The quote wizard 220 may further validate data that is retrieved from the customer 140. Validation may be performed before the quote wizard 220 further communicates the data to the back-end 210. The initial validation may assist to confirm that certain items match. For example, when a zip code is entered, the customer may be directed to select from a possible city and state possibilities for that specific zip code. When an automobile's VIN number is entered, the customer may be directed to select from those vehicles that could possibly contain that VIN. If a moving violation is entered into the system, the customer may be prompted to select from various universal violations that in turn may be mapped to thousands of different surcharges for each company rated. If an invalid date of birth is entered or a driver is too young or old for licensing, the customer may be prohibited from proceeding. If other problematic data is entered (e.g., occupation, etc.), the applicant may be prohibited from proceeding. Information pertinent to the initial quote may be stored on an individual server designated for the customer. Further validation may be required to actually sell or bind the policy. This information may be handled by the purchase wizard. This secondary validation process may gather additional information to complete the binding of the transactions. This additional data may be stored on an Oracle database. This information may contain information on completed deal and partially completed deals in which an email address has been obtained.

After an initial quote is provided and the client may proceed to purchase the policy, the purchase wizard may pick up where the quote wizard left off to complete the transaction. It is at this point that the purchase wizard may gather all the required underwriting information needed to bind the policy. The majority of the underwriting information needed to properly rate and sell a policy may be handled by the quote wizard on a driver detail screen. Examples of such information gathered may include the following: duration of insurance, citizenship, insurance cancellations, driver impairments, valid email and password, valid driver's license, and/or the like.

A purchase wizard 230 may be similar in many respects to a quote wizard 220. The customer may choose to purchase a quoted insurance policy. Then, the purchase wizard 230 may dynamically and intelligently prompt the customer 140 to enter a limited set of information necessary to purchase the insurance policy. The purchase wizard may gather additional underwriting information such as the listing of any excluded drivers that need to be listed on the policy, a re-validation of the vehicle's VIN, the re-validation of policy coverages, and a re-validation of the price and term of the policy, for example. Once this information is gathered, the purchase wizard may prompt the customer to enter various forms of payment for the policy. The purchase wizard may process the payment, validate the availability of funds and may sweep the funds into the owner of the Insurance Agency's bank account. The purchase wizard may store all information to the Oracle Back-end database and may electronically transmit pertinent documents to the email address provided by the customer.

The purchase wizard 230 may validate and/or re-validate data retrieved from the customer 140. For example, the purchase wizard 230 may revalidate the limited set of data retrieved by the quote wizard 220. The purchase wizard 230 may also validate the limited set of information necessary to purchase the insurance policy.

The wizards 220 and 230 may be one or more applications that communicate/interact with the back-end 210 and the interface 240. For example, the wizards may be part of a Rich Internet Application (“RIA”). For example, the wizards in conjunction with the customer interface 240 may be implemented with a programming environment, such as AJAX. The wizards and/or the interface 240 may also provide validation of the retrieved information at the customer interface 240 and/or the back-end 210.

A back-end 210 may interact with the customer interface 240 and the wizards 220, 230. The back-end 210 may be a computer system itself. For example, the back-end may include one or more of the following: databases, servers, processors, non-perishable memory, perishable memory, communications ports, etc. The quote wizard may store data on an agency's database. Once the client goes beyond the quote screen and makes an initial commitment to buy, the purchase wizard may store all completed and partially completed transactions to a master Oracle database.

The back-end 210 may execute one or more applications. For example, the back-end may execute applications written in programming languages, such as Visual FoxPro, or other “.net” languages. One such application(s) may be a ratings engine. The ratings engine may interact with other system components to provide a quote. For example, the ratings engine may employ various sets of rules provided by the insurers. The ratings engine may use a database from which quotes are determined.

The back-end 210 may, for example, receive information from the customer 140 through the wizards and interface. The back-end 210 may process the information with the ratings engine to provide a quote. The back-end may also process the information to execute an insurance policy transaction.

The payment of the policy may be automatically processed by the virtual agency (e.g., 120, or system 200). The virtual agency may substantially immediately (e.g., within seconds or minutes) email to the customer 140 various documents relating to a purchased insurance policy: e.g., application, declaration page, identification cards, and/or other legal documentation. Thus the virtual agency may automatically process and complete an insurance transaction without any intermediate intervention from a human agent or an insurer.

Turning to FIG. 3, a flowchart 300 for a method of providing insurance transactions is shown, according to an embodiment of the present invention. The flowchart is shown to have various steps. Some steps may be omitted, and/or may be performed in a different order. Some steps may be performed substantially simultaneously.

At step 310, a customer is permitted to access a retail website for quoting and selling vehicle insurance. The website may include a customer interface, or at least a portion thereof (e.g., customer interface 240). The retail website may be an interface to a virtual agency. The website may be operated by a brokering middleman who has relationships with two or more insurers. The website may allow, as will be discussed further, the customer to automatically purchase a legally binding insurance policy and receive documentation without any human intervention or further intermediary approval. The website may offer persistent data sessions, allowing a customer to return after a period of time without losing previously entered information. The website may include a Rich Internet Application, and may dynamically respond to interactions from the customer.

At step 320, a first set of information about the customer and a vehicle of the customer is retrieved. The first set of information may be retrieved through assistance of a quote wizard (e.g., quote wizard 220). The first set of information may be limited. An example of a limited set of information is shown in FIG. 4. The first set of information may include customer and vehicle information. The first set of information may be the minimum amount of data necessary to provide a vehicle insurance quote. The size of the first set of information may vary based on certain customer-provided information (e.g., the set may be larger if there are driving violations entered). The quote wizard, and/or the back-end, may assist with verification of the first set of information. Validation of vehicle's VIN, the matching of city, state and zip code, acceptable date of birth, and/or the like are all examples of the initial questions that may be resolved in the initial validation process.

At step 330, at least two insurance rates from at least two insurers are determined. The rates may be determined by a virtual agency. Insurance rates may be determined from any number of insurers. The agent that provides the virtual agency may be an authorized broker for the insurers. The rates may be determined through a rating engine, for example. The rates may have a variety of associated aspects—e.g., type of coverage (full-coverage, liability only, etc.), deductibles, coverage limits, etc. The rates may be determined pursuant to a database of rate information corresponding to the insurers. The rates may also be determined by using calculations in accordance with the procedures of the various insurers. The rates may be determined for each insurer. The rates may be determined by a back-end. The rates may be determined by an application running on the back-end, in a language such as Visual FoxPro. The rates may be calculated without any intermediate intervention from the insurers. The rates may be provided substantially immediately—e.g., with seconds or minutes.

At step 340, a preferred insurance rate corresponding to a preferred insurance policy is selected. The selection may be from the various rates determined at step 330. The selection may be made according to a selection preference—e.g., lowest price. The selection may be made automatically. Additionally, the customer may have input during the selection process. For example, the customer may be provided two or more rates. As an example, a customer may request certain coverage limits, deductibles, and policy types that may influence the selection process. The preferred insurance rate may further be displayed to the customer 140—e.g., through a customer interface.

At step 350, an option to the customer to purchase the selected preferred insurance policy is provided. The customer may further interact with the interface to select a different insurance policy, if the quoted policy is not satisfactory. The customer may interact, for example, by altering various aspects of the insurance policy: coverage type, deductibles, coverage limits, etc.

If the customer chooses to purchase the policy, at step 360, a second limited set of information about the customer and a vehicle of the customer is retrieved. The second set of information may be retrieved through assistance of a purchase wizard (e.g., purchase wizard 230). The second set of information may be limited. An example of a second limited set of information is shown in FIG. 5. The second set of information may include additional customer, vehicle, and purchase payment information (e.g., credit card, check, PayPal®, etc.). The second set of information may be the minimum amount of data necessary to transact the purchase of an insurance policy. The size of the second set of information may vary based on certain customer-provided information. The purchase wizard, and/or the back-end, may assist with verification of the first set of information.

At step 370, legally binding documents for the purchased policy are communicated substantially immediately to the customer without intermediately involving the insurer. The legally binding documents may include the following: insurance identification, application, declaration page, and/or the like. One or more of the documents may be communicated through electronic media—e.g., email, fax, etc. Documents may additionally be communicated via postal service(s). Documents may be communicated substantially immediately—in a matter of seconds or minutes. The virtual agency may receive from each insurer a block of policy numbers. The virtual agency may use one of the policy numbers from a block corresponding to the selected insurer. In this manner, the virtual agency may execute the transaction for the legally binding insurance policy without any need for intermediate interaction with the selected insurer (or a human being).

At step 380, information regarding the purchased policy is communicated to the insurer. The information may be communicated automatically or manually to the selected insurer (e.g., uploaded to the insurer automatically).

As an illustrative example method 300 may be performed in the following manner. A customer seeking vehicle insurance accesses a website. The website is part of a virtual agent. The customer wants to see a quote for an insurance policy to evaluate whether he/she will purchase the policy.

Through the user interface of the website, the customer is prompted to enter a limited first set of information. The information is intelligently and dynamically retrieved through the assistance of a quote wizard. Only the information necessary to provide a quote is prompted and retrieved.

The quote wizard verifies the first limited set of information and then communicates the first set of limited information to a back-end. The back-end contains a ratings engine that computes at least two insurance rates corresponding to at least two insurers. The back-end selects the policy with the lowest price, and communicates the policy information to be displayed on the website interface.

The customer views the quote, and decides to purchase the insurance policy. The virtual agency, through a purchase wizard, intelligently retrieves a second limited set of information from the customer. The second set of information includes credit card information. The purchase wizard verifies the credit card information. The virtual agent then automatically executes the insurance transaction. The selected insurance policy is issued from a block of insurance policy numbers provided by the insurer to the virtual agency. The identification card, declaration, and application are emailed to an address provided by the customer. The customer then has a legally binding insurance policy covering his/her vehicle. Subsequently, the virtual agency then uploads information regarding the purchased policy to the selected insurer. Throughout the process, the only human interaction is from the customer. The rest of the steps are performed automatically.

Thus, embodiments of the present application provide methods and systems that provide a more efficient process for obtaining vehicle insurance. Additionally, embodiments of the present application provide methods and systems that increase exposure and market-share for smaller insurances. Moreover, embodiments of the present application provide methods and systems that allow smaller insurers to compete in cyberspace more effectively.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. For example, features may be implemented with software, hardware, or a mix thereof. Furthermore, while embodiments disclosed herein primarily relate to vehicle insurance, many of the same principles would also apply to methods and systems for purchasing other types of insurances. Therefore, it is intended that the invention not be limited to the particular embodiment disclosed, but that the invention will include all embodiments falling within the scope of the appended claims.

1. A method for providing insurance comprising:
permitting a customer to access a retail website;
retrieving intelligently, from said customer through said website, a first limited set of information pertaining to said customer and a vehicle of said customer;
determining, from said first limited set of information, a first insurance rate corresponding to a first insurance policy from a first insurer and a second insurance rate corresponding to a second insurance policy from a second insurer, wherein said first and second rates are determined without intermediately consulting said first and second insurers;
evaluating which of said first and second rates is preferable to said customer to determine a preferred insurance policy;
displaying information corresponding to said preferred insurance policy to said customer; and
providing an option to said customer to purchase said preferred insurance policy.

2. The method of claim 1 further comprising retrieving intelligently, from said customer through said website, a second limited set of information pertaining to said customer and a vehicle of said customer when said customer opts to purchase said preferred insurance policy.

3. The method of claim 2 further comprising communicating substantially immediately, to said user, legally binding documents for said preferred insurance policy after said user purchases said preferred insurance policy to form a purchased insurance policy.

4. The method of claim 3, wherein said communicating said legally binding documents is performed without intermediately involving said first and second insurers.

5. The method of claim 3 further comprising automatically uploading information corresponding to said purchased insurance policy to a selected one of said first and second insurers.

6. The method of claim 1, wherein said first limited set of information is intelligently retrieved through assistance of a quote wizard.

7. The method of claim 2, wherein said second limited set of information is intelligently retrieved through assistance of a purchase wizard.

8. The method of claim 1 further providing an option to said customer to customize said quote by adjusting at least one aspect of said preferred insurance policy, where said at least one aspect is at least one of: a coverage limit and a deductible.

9. The method of claim 1, wherein said information corresponding to said preferred insurance policy comprises a rate for liability only, and a rate for full coverage.

10. The method of claim 1, wherein said website provides persistent sessions to retain information corresponding to interactions of said customer.

11. A virtual agency for facilitating insurance transactions comprising, the virtual agency comprising:
an interface for allowing customer interaction;
a back-end for facilitating computation of a plurality of insurance rates from a corresponding plurality of insurers; and
a quote wizard for intelligently retrieving a first limited set of information from said customer corresponding to personal and vehicle information of said customer, wherein said quote wizard communicates said first limited set of information to said back-end,
wherein said back-end generates a preferred insurance rate from said plurality of insurance rates for display to said customer through said interface.

12. The virtual agency of claim 11, further comprising a purchase wizard for intelligently retrieving a second limited set of information from said customer corresponding to personal and vehicle information of said customer, wherein said purchase wizard communicates said second limited set of information to said back-end, wherein said back-end automatically executes a legally binding insurance policy and communicates said legally binding insurance policy to said customer.

13. The virtual agency of claim 12, wherein each of said quote and purchase wizards comprise at least one rich internet application.

14. The virtual agency of claim 12, wherein said legally binding insurance policy is selected from a block of insurance policies provided by a selected insurer to said virtual agency.

15. The virtual agency of claim 12, wherein said back-end automatically communicates information corresponding to said legally binding insurance policy to a selected one of said plurality of insurers.

16. A system for providing vehicle insurance comprising:
a customer;
a first limited set of information corresponding to said customer, and a vehicle of said customer;
a plurality of insurers;
a plurality of insurance rates corresponding to said plurality of insurers; and
a virtual agency representing said plurality of insurers to said customer,
wherein said virtual agency automatically calculates said plurality of insurance rates, and wherein said virtual agency automatically selects a preferred insurance rate from said plurality of insurance rates, and wherein said virtual agency executes and communicates insurance policy documents to said customer without any further interaction from a human and a selected one of said plurality of insurers to form a legally binding insurance policy.

17. The system of claim 16, wherein said virtual agency further comprises a quote wizard for intelligently retrieving a first limited set of information from said customer for calculating said plurality of insurance rates.

18. The system of claim 16, wherein said virtual agency further comprises a purchase wizard for intelligently retrieving a second limited set of information from said customer for purchasing a selected one of said plurality of insurance rates.

19. The system of claim 16, wherein said virtual agency receives from each of said plurality of insurers a corresponding plurality of blocks of insurance policy numbers to facilitate the execution communication of said insurance policy documents.

20. The system of claim 16, wherein said virtual agency automatically communicates information corresponding to said legally binding insurance policy to a selected one of said plurality of insurers.
